(19) United States
(12) Patent Application Publication
(10) Pub. No.: US 2012/0209926 A1
(43) Pub. Date: Aug. 16, 2012

(54) AUTOMATIC PROVISIONING OF INSTANT MESSAGING AND SOCIAL NETWORKING SERVICES

(76) Inventors: Ari Backholm, Los Altos, CA (US); Michael Luna, San Jose, CA (US)

(21) Appl. No.: 13/372,145

(22) Filed: Feb. 13, 2012

Related U.S. Application Data
(60) Provisional application No. 61/441,788, filed on Feb. 11, 2011.

(51) Int. Cl. G06F 15/16

(52) U.S. Cl. 709/206

(57) ABSTRACT

A system and method automate the process of provisioning user accounts for a selected service, thereby allowing ease of creation of new communities easier. By automating provisioning and thereby eliminating steps that require end user interaction, the present technology facilitates community creation. In particular, the system may automatically determine existing identification, such as a telephone number associated with a user's mobile device, to provision the account without requiring additional interaction from the user. The system may also automatically connect user accounts in the selected by using existing trust relationships, such as contact information stored in a contacts database.

### CLAIM OF PRIORITY

This application claims priority to U.S. Provisional Patent Application No. 61/441,788 entitled “AUTOMATIC PROVISIONING OF INSTANT MESSAGING AND SOCIAL NETWORKING SERVICES,” which was filed on Feb. 11, 2011, the contents of which are expressly incorporated by reference herein.

### FIELD OF TECHNOLOGY

The present disclosure relates generally to a user environment and more particularly to a mobile user environment for using existing user identification to automatically provision user accounts in instant messaging or social networking services.

### BACKGROUND

Provisioning is an important aspect of providing instant messaging and social networking services. In the context of instant messaging and social networking, provisioning often involves two steps: creation of a personal account to the service; and establishing links (trust relationships, “buddying”) with other accounts. Creating a personal account an instant messaging or social networking service is often a manual process that involves establishing service-specific credentials, such as a user ID and password. Also, establishing links with other accounts is often a manual process, which involves sending linking requests to other users and the other users accepting the linking requests. Because of these manual provisioning processes, establishing new communities is often slow, and existing communities, such as those of Yahoo®, MSN®, Facebook®, Twitter® and Google®, command a competitive advantage and place an entry barrier to a new vendor trying to establish its own community.

### BRIEF DESCRIPTION OF THE DRAWINGS

FIG. 1A illustrates examples of devices with user environments able to provide automatic provisioning of user accounts.

FIG. 1B depicts an example communication network environment suited to incorporating at least one embodiment of an automatic provisioning system.

FIG. 2 depicts a block diagram illustrating an example mobile architecture for at least one embodiment of the automatic provisioning system.

FIG. 3 depicts a block diagram illustrating example components of an automatic provisioning system to facilitate provisioning new user accounts.

FIG. 4 is a flowchart of an overall process for operating the automatic provisioning system.

FIG. 5 is a flowchart of a process for provisioning a new user account on a selected service.

FIG. 6 is a flowchart of a process for determining a telephone number associated with a device.

FIG. 7 is a flowchart of a process for managing invitations according to an embodiment of the system.

FIG. 8 depicts screenshots showing a chat application utilizing SMS-based registration.

FIG. 9 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the present disclosure include systems, apparatuses and methods of unified access and management of events across multiple applications and associated contacts thereof. Embodiments of the present disclosure further include systems, apparatuses, and methods for generating a user interface on a mobile device, and more specifically, to the generation of a unified messaging interface that enables a user to interact with multiple messaging applications and is organized based on a user's contacts.

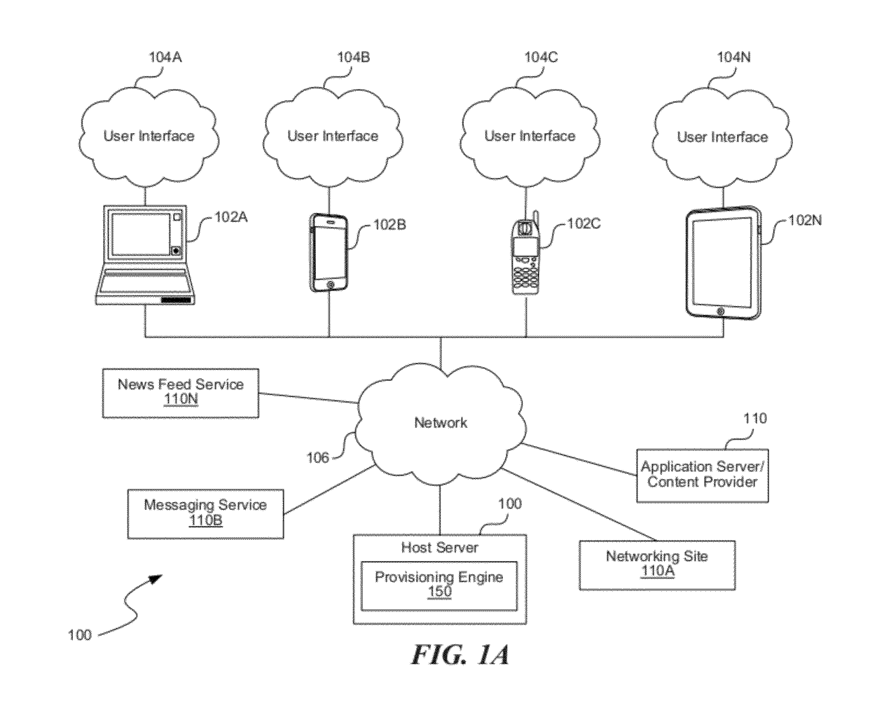

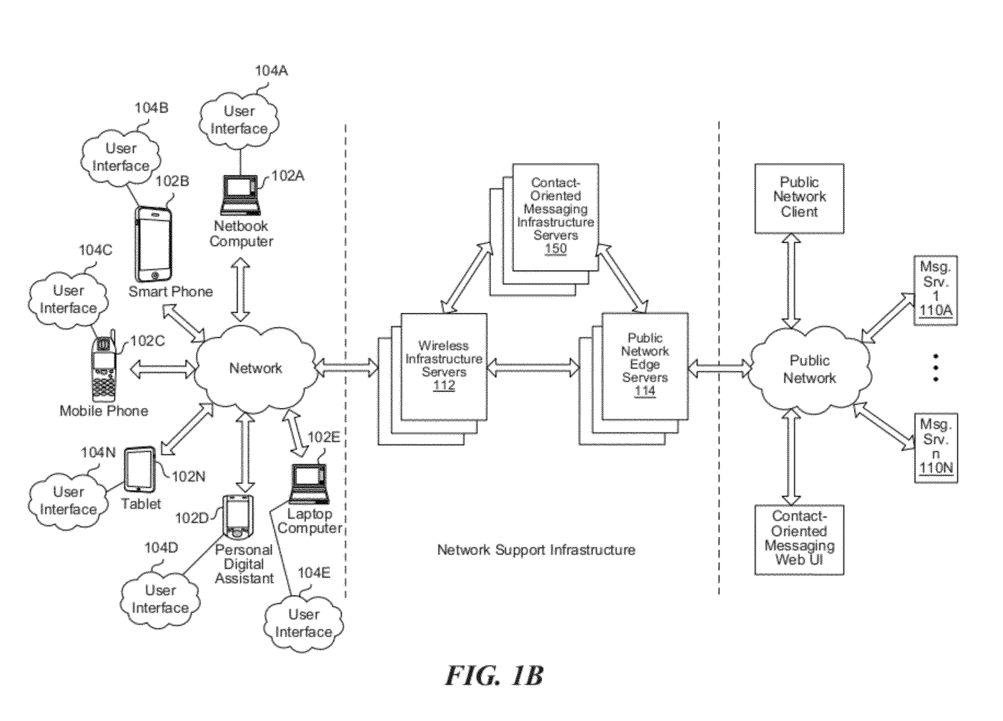

FIG. 1A illustrates examples of devices 102A-N with user environments able to provide automatic provisioning of user accounts.

Client devices 102A-N may be any system and/or device, and/or any combination of devices/systems that is able to establish a connection with another device, a server and/or other systems such as host server provisioning network servers 110a-n. Client devices 102A-N each typically include a display and/or other output functionalities to present information and data exchanged among the devices 102A-N and/or provisioning network servers 110a-n.

For example, the client devices 102A-N can include mobile or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g., an iPad), a handheld console, a handheld gaming device or console, an iPhone, and/or any other portable, mobile, handheld devices, etc. In one embodiment, the client devices 102A-N and provisioning network servers 110 are coupled to one or more networks, which may include a public network. In some embodiments, the devices 102A-N may be directly connected to the provisioning network servers 110a-n.

The input mechanism on client devices 102A-N can include a touch screen keypad (including single touch, multi-touch, gesture sensing, etc.), a physical keypad, or a combination of the above. The automatic provisioning system disclosed herein can be initiated and used with any conventional or known input device including but not limited to physical keyboard, touch screen display, motion sensor, microphone, mouse, other types of pointer devices and any additional input device.

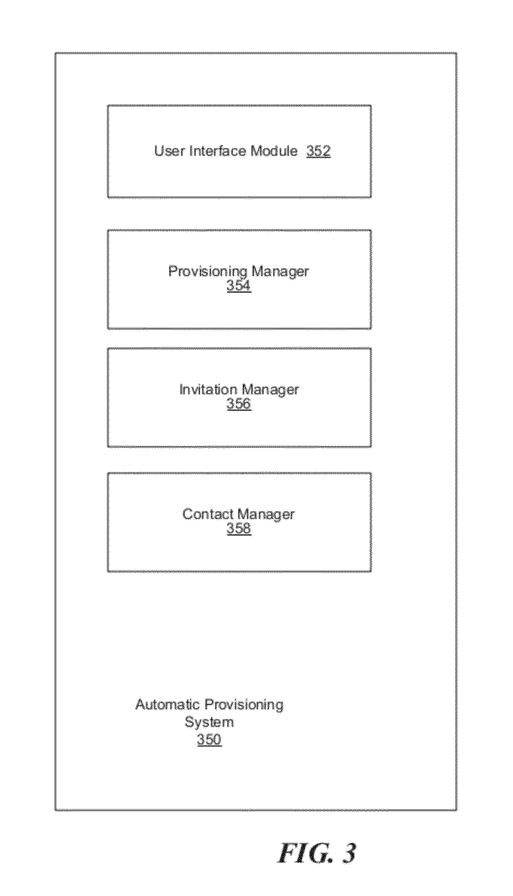

The automatic provisioning system can be provided locally by the devices 102A-N through the mobile device manufacturer, provided through the device operating system, by a network service provider, through a downloaded widget from a third party site, network service provider, or from a host server 100. Functions and techniques performed by the automatic provisioning system on devices 102A-N for provisioning user accounts and creating links to other user accounts are described in detail with further reference to the example of FIGS. 3-7.

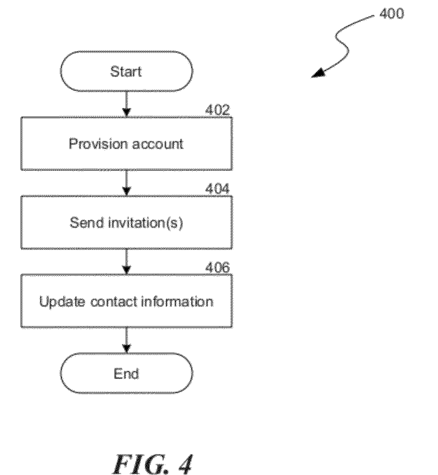

In one embodiment, automatic provisioning functionalities are in part or in whole provided remotely to the devices 102A-N, for example by a host server 100. For example, a host server 100 may include a provisioning engine accessible over the network to support the processing needed to provision user accounts and associate contacts with the new user accounts, such as the processing discussed below with reference to FIGS. 4-7. The provisioning functionality, when provided remotely, may be accessed by the devices 102 in the cloud.

Functions and techniques performed by a provisioning engine, which can reside on the client devices 102 in part or in whole and/or a host server 100 in part or in whole and the components therein are described in detail with further references to the examples of FIGS. 3-7.

For example, the automatic provisioning system can use an existing user identification to provision instant messaging and social networking services. By using an existing user identification, the user does not have to create a new identification, such as a new username. Further, according to an embodiment, the existing user identification is chosen such that it can be programmatically authorized, without requiring that the user create a secondary authentication mechanism, such as a password or PIN code.

In some embodiments, the existing user identification is the telephone number associated with the user's user device, such as the user's mobile device. Further, according to an embodiment, the telephone number is obscured. For example, upon obtaining the telephone number associated with the user's mobile device, the telephone number may be used to provision an instant messaging and/or social networking service without the user's interaction. For example, the telephone number may be submitted to an instant messaging and/or social networking service, which can use the telephone number to pull down information about the user, such as the user's name, address, email, etc., and use that information to provision the instant messaging and/or social networking service.

According to an embodiment, trust relationships between users are identified and used to build linkages between users. Traditional instant messaging and social networking services rely on user's to “invite” other users and the other users to “accept” the “invitations.” Thus, these traditional instant messaging and social networking services require two proactive steps (i.e., inviting and accepting) from the user for each link, thereby slowing down the creation of the community.

An embodiment of the present invention uses the address book of a user device as repository of both “invitations” and “acceptances.” An entry in the address book of an inviter's mobile device represents an invitation sent on behalf of the inviter. This invitation may or may not be visible to the inviter, and may or may not be processed automatically on the inviter's behalf. An entry in the address book of the invitee's mobile device represents an acceptance to an invitation sent in the step above. If an entry for the inviter exists in the invitee's address book, the invitation may be automatically accepted, without user interaction. According to an embodiment, all invitations are automatically accepted. If an entry for the inviter does not exist in the invitee's address book, the invitee's user device client may utilize the invitee's telephone number to provision the invitee in the relevant instant messaging or social networking service if needed, and the invitee may be prompted to accept the invitation and/or add the inviter to his/her address book.

In addition to or instead of identifying trust relationships between users and using those trust relationships to build linkages between users, embodiments are provided for automatically updating the contact details of linked persons in instant messaging and/or social networking services. For example, embodiments may automatically update a sender's information (telephone number, name, address etc) in a recipient's telephone book. This solves the problem of outdated contact details. As the linkage between the two users is established, according to an embodiment, the originating user device sends updated contact details to the receiving user device, which, based on the trust relationship, may accept the change and update the receiving user device's address book automatically. According to an embodiment, mobile telephone address books are augmented to include functionality for pending invitations, contact information updates, etc.

Although embodiment are described herein with reference to instant messaging and social networking services, it should be appreciated that any service that requires provisioning may be considered. Such services include email services, customer affinity programs, and gaming, shopping, banking, news/information, education, and travel related services.

The network 106, over which the client devices 102A-N, the provisioning network servers 110a-n, and other devices communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, and other services through any known or convenient protocol, such as the TCP/IP protocol, Open System Interconnections (OSI), FTP, UPnP, iSCSI, NSF, ISDN, PDH, RS-232, SDH, SONET, etc. The network 106 can be any collection of distinct networks operating wholly or partially in conjunction to provide connectivity to the client devices 102A-N and the host server 100 and may appear as one or more networks to the serviced systems and devices. In one embodiment, communications can be achieved by a secure communications protocol, such as secure sockets layer (SSL), or transport layer security (TLS).

In addition, communications can be achieved via one or more networks, such as one or more of a Local Area Network (LAN), Wireless Local Area Network (WLAN), a Personal Area Network (PAN), a Campus Area Network (CAN), a Metropolitan Area Network (MAN), a Wide Area Network (WAN), a Wireless Wide Area Network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

FIG. 1B depicts an example communication network environment suited to incorporating at least one embodiment of an automatic provisioning system.

Mobile devices 102A-N may communicate with one another and with non-mobile devices through a wireless network, a wireless network support infrastructure, a public network and/or multiple services 110A-N. The wireless network may incorporate and/or participate in a communication network utilizing any suitable wireless communication protocol including wireless telephony protocols and wireless internet protocols. The public network may incorporate and/or participate in a global computer network. In at least one embodiment, the public network may be replaced by and/or supplemented with one or more private and/or enterprise networks.

The provisioning network servers 110a-n may correspond to different modes or types of communication. For example, the provisioning network servers 110a-n can include voicemail, email, a short messaging service (e.g., SMS), chat (e.g., internet relay chat), instant messaging (IM), fixed length text messages viewable by a set of subscribers (e.g., “TWITTER”), and personal status updates viewable by a set of authorized subscribers (e.g., “FACEBOOK”). The messages sent between mobile devices and servers for the purpose of automatically provisioning instant messaging and social networking services may correspond to different modes or types of communication. For example, the messages may include short messaging service (SMS) messages, wireless application protocol (W AP) messages, HTTP, chat (e.g., internet relay chat), fixed length text messages viewable by a set of subscribers (e.g., Twitter®), personal status updates viewable by a set of authorized subscribers (e.g., Facebook®), voice messages, e-mail messages, etc. The messages and information communicated may incorporate any suitable media format including plain text, formatted text, rich text, graphics, images, audio, video, animations and simulations. In one embodiment, one or more of the provisioning network servers 110a-n can be incorporated into the wireless network support infrastructure.

The wireless network support infrastructure may include a set of wireless infrastructure servers facilitating a wide variety of wireless infrastructure services including communication connection switching and/or routing, service provisioning and/or repair, resource usage monitoring and/or billing, as well as security and/or anti-fraud services. The wireless network support infrastructure may further include a set of public network edge servers that facilitate and govern communication between the wireless network and the public network. Still further, the wireless network support infrastructure may include a set of provisioning servers collectively configured at least to facilitate the provisioning of instant messaging and social networking services. Various aspects of provisioning services may be customized and/or configured with a web user interface (e.g., an application programming interface or a graphical user interface) accessible via the public network (as shown in FIG. 1B) and/or incorporated into the wireless network support infrastructure. Such a user interface may be accessible with a public network client (e.g., a personal computer incorporating a web browser) connected to the public network and/or a mobile device (e.g., incorporating a mobile web browser).

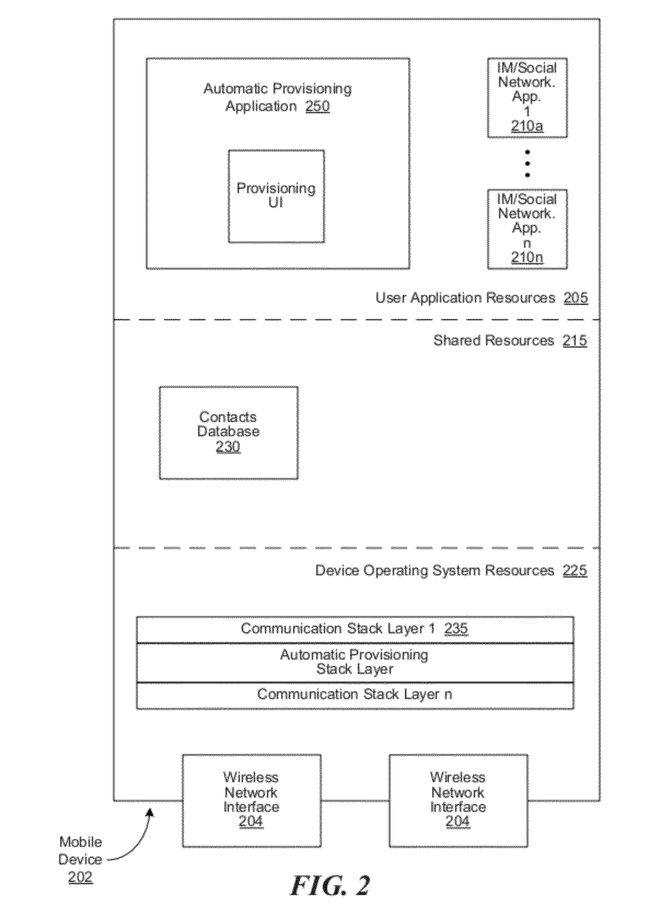

FIG. 2 depicts a block diagram illustrating an example mobile architecture for at least one embodiment of an automatic provisioning system.

The mobile device may include multiple instant messaging and/or social networking applications implemented with a set of user application resources of the mobile device. The multiple instant messaging and/or social networking applications may correspond to the multiple messaging and social networking applications services described above with reference to FIG. 1. The mobile device may further include a communication stack (e.g., a messaging protocol stack such as a TCP/IP stack) incorporating multiple layers configured at least to facilitate communication with one or more wireless network interfaces. The communication stack may be incorporated into and/or implemented with a device operating system set of resources of the mobile device. The communication stack may include an automatic provisioning stack layer configured at least to monitor characteristics of messages and/or messaging patterns over time to and/or from the messaging and/or social networking applications. Such monitored information may be available to an automatic provisioning application implemented with the user application resources of the mobile device.

The mobile device may maintain a contacts database that is shared to various degrees with the instant messaging and/or social networking applications and the automatic provisioning application. Access to the contacts database may be subject to various controls and/or policies enforced by an operating system of the mobile device. For example, different applications may have no access, read-only access, read-update access and/or read-update-create access to the contacts database. In at least one embodiment, the wireless network support infrastructure may maintain a back-up copy of the contacts database.

FIG. 3 depicts a block diagram illustrating example components of an automatic provisioning system 350 to facilitate provisioning new user accounts. As used in this paper, a “module,” a “manager,” a “handler,” or an “engine” includes a general purpose, dedicated or shared processor and, typically, firmware or software modules that are executed by the processor. Depending upon implementation-specific or other considerations, the module, manager, handler, or engine can be centralized or its functionality distributed. The module, manager, handler, or engine can include general or special purpose hardware, firmware, or software embodied in a computer-readable (storage) medium for execution by the processor. As used in this paper, a computer-readable medium or computer-readable storage medium is intended to include all mediums that are statutory (e.g., in the United States or under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, etc.), but may or may not be limited to hardware.

The system 350 includes a user interface module 352, which provides a user interface for a user to control aspects of the system 350. Because the system automatically provisions accounts without user intervention, the user interface module 352 needs to provide very few interface elements. As discussed below, in some embodiments, the user interface module 352 provides interface elements to enable the user to initiate the provisioning process. The user interface module 352 may also provide an interface to a contact database to enable a user to select contacts to receive invitations to a particular service.

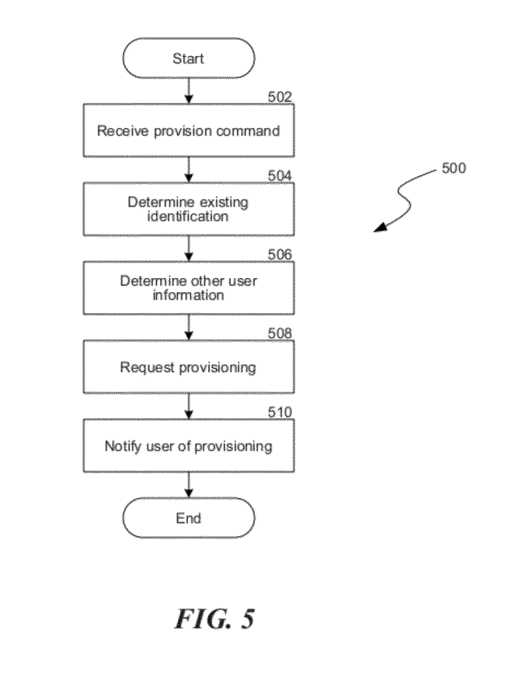

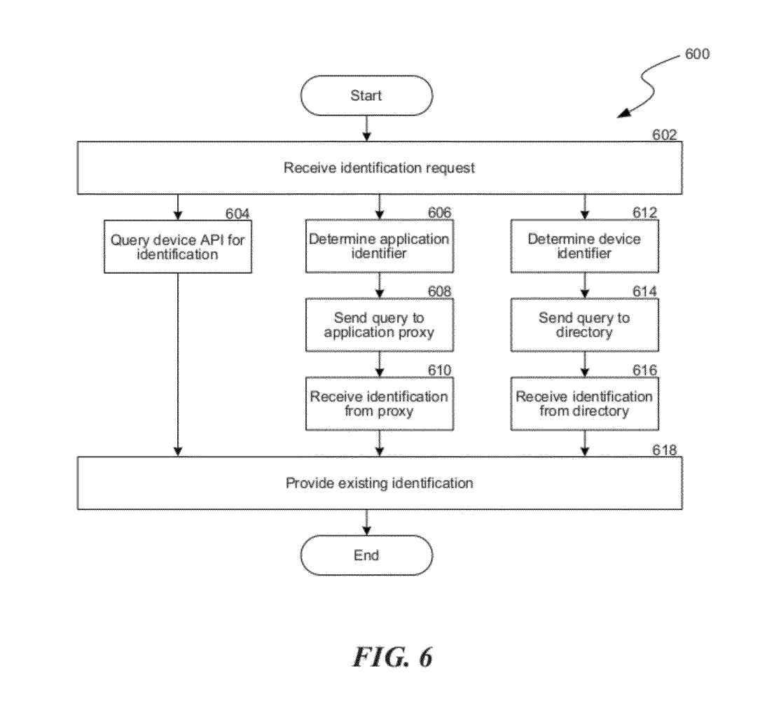

The system 350 includes a provisioning manager 354, which manages the process of automatically provisioning a user account with a selected service. This process is discussed in greater detail below with reference to FIG. 5. The system 350 also includes an invitation manager 356, which processes invitations handled by the system. In particular, the invitation manager 356 may be configured to send invitations to other users either automatically or in response to a user command. The invitation manager 356 may also handle incoming invitations, as discussed below with reference to FIG. 6. The system 350 also includes a contact manager 358, which provides an interface to a contacts database associated with the user's device (e.g., the contacts database 230 of FIG. 2). The contact database may be an address book stored locally on the device or accessed remotely through a network interface. The contact manager 358 provides contact information in response to requests from the user interface module 352, the provisioning manager 354, or the invitation manager 356. In some embodiments, the contact manager 358 may also automatically update the contacts database in response to information received from other users.

FIG. 4 is a flowchart of an overall process 400 for operating the automatic provisioning system. Processing begins at block 402, where the system provisions a user account on a selected service, such as an instant messaging service or a social networking service. After the account has been provisioned, processing proceeds to block 404, where the system sends invitations to one or more invitees to connect through the selected service. Processing then proceeds to block 406, where the system may update stored contact information for connections made through the selected service. The process 400 then ends. These steps are discussed in greater detail below with reference to FIGS. 5-7.

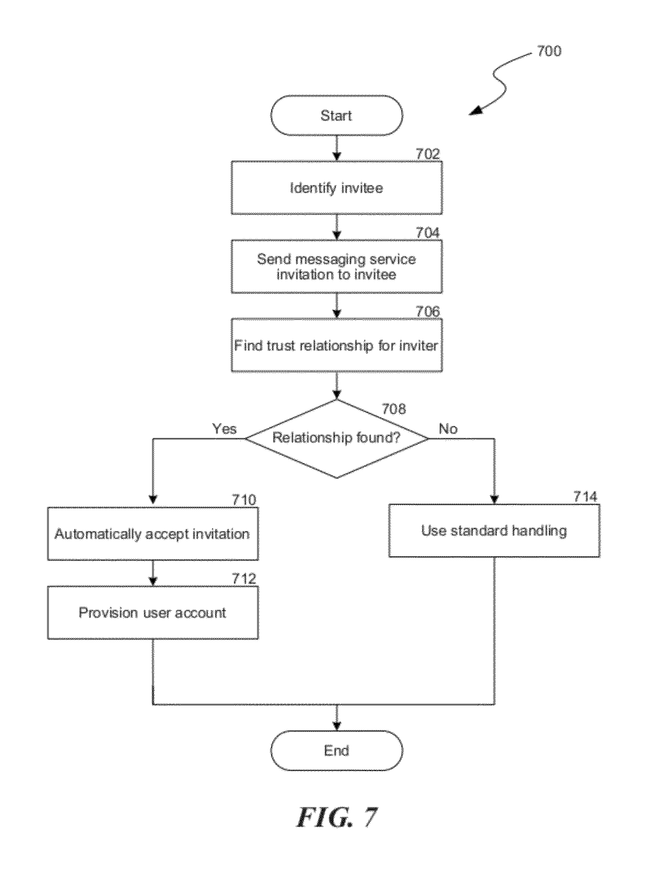

FIG. 5 is a flowchart of a process 500 for provisioning a new user account on a selected service. Processing begins at block 502, where the system receives a command to provision a new user account for a selected service. In some cases, the command may be generated in response to the user selecting an element of the user interface indicating that the user wants to join a selected service. In other cases, the command may be automatically generated by an application; for example, the system may generate a provisioning command when the user receives an invitation from a trusted user. This scenario is discussed below with reference to FIG. 7.

Processing then proceeds to block 504, where the system determines an existing identification for the user. Using the existing identification avoids requiring the user to create a new identifier and may also be used to avoid a need for the user to create a secondary authentication mechanism, such as a password or PIN. In some embodiments, the system is operating on a mobile device and the existing identification is a telephone number associated with the mobile device. This embodiment has the advantage that the mobile device has a unique telephone number and is typically associated with a single user. Methods for determining the device's telephone number are discussed below with reference to FIG. 6.

Processing then proceeds to block 506, where the system uses the existing identification to retrieve other user information, such as the user's name, address, or email. This may be determined, for example, based on information that the user has previously provided to the application during a prior registration process. Processing then proceeds to block 508, where the system uses the existing identification or the other user information to provision a new user account with the selected service. In this step, the system communicates with the selected service to automatically perform the registration steps required by the selected service. These steps will generally vary depending on the selected service. Processing then proceeds to block 510, where the system notifies the user that provisioning has been completed. The process 500 then ends.

An advantage of the process 500 is that the system can automatically provision the account without requiring additional steps or interaction by the user. By using the device's telephone number, the system can determine all information needed to provision the new user account. The system can then provision the user account in the background without requesting additional information.

FIG. 6 is a flowchart of a process 600 for determining a telephone number associated with a device. The process 600 may be used to carry out the processing of block 504 of FIG. 5. Processing begins at block 602, where the system receives a request for the existing identification. The process 600 then provides multiple possible methods for responding to the request. According to one method, processing proceeds to block 604, where the system queries an API on the device to retrieve the telephone number. For example, such an API may be provided by an operating system on a smartphone, such as the iOS operating system supplied by Apple, Inc. of Cupertino, Calif.

Alternatively, the system may use server-based solutions to determine the device's telephone number. According to a second method, processing instead proceeds to block 606, where the system determines an application-specific identifier. The application-specific identifier may be, for example, a unique identifier associated with an application present on the device, such as the application associated with the user interface of FIG. 3. Processing then proceeds to block 608, where the system sends a query to a proxy server associated with the application. The query may be sent by placing a network request (e.g., HTTP or SMS) with an automatically generated service-internal identifier (e.g., 7TP address) through a proxy that appends the telephone number associated with the user's device to the request. According to this exemplary technique, a server component may receive the request, map the service-internal identifier to the telephone number, and, if necessary, return the telephone number to client software running on the user device through an earlier association created between the client software and the server. Processing then proceeds to block 610, where the system receives the existing identification from the proxy server.

According to a third method, processing proceeds to block 612, where the system determines a device identifier for the user's device. A device identifier may be any information associated with the device sufficient to uniquely identify it, such as an Internet Protocol (IP) address or Medium Access Control (MAC) address. Processing then proceeds to block 614, where the system provides the device identifier to a network directory. The network directory then looks up the existing identification based on the device identifier based on information previously provided to the directory. Processing then proceeds to block 616, where the system receives the existing identification from the directory.

After system has determined the existing identification, processing proceeds to block 618, where the existing identification is provided to the rest of the system for use in provisioning the user account. The process 600 then ends.

FIG. 7 is a flowchart of a process 700 for managing invitations according to an embodiment of the system. Processing begins at block 702, where the system identifies an invitee. In some embodiments, the invitee is identified based on a user selecting or entering one or more contacts to receive invitations. In other embodiments, invitees are automatically identified based on a pre-existing trust relationship, such as inclusion as a contact in the inviter's contacts database.

Processing then proceeds to block 704, where the system sends an invitation to the invitee to join the selected messaging service. Processing then proceeds to block 706, where a corresponding system on the invitee's device determines whether a trust relationship exists with the inviter. As discussed above, a trust relationship may be determined by finding the information associated with the inviter in the invitee's contacts database (e.g., address book).

Processing then proceeds to decision block 708, where the process 700 branches based on whether a trust relationship exists. If a trust relationship exists, processing proceeds to block 710, where the system automatically accepts the invitation without requiring additional action by the invitee. The system can do this because the existence of the trust relationship indicates a preexisting willingness to be connected through the selected service.

Processing then proceeds to block 712, where the system automatically provisions a new user account for the selected service. The system performs this step if the invitee is not already a member of the selected service. This step may be performed according to the process described above with reference to FIG. 5. In this way, the system can automatically create a set of connections for users based on existing trust relationships while reducing the effort required by the users.

If a trust relationship does not exist with the inviter, processing instead proceeds to block 714, where the system uses standard handling for invitations. This may include, for example, presenting the invitee with a notification of the invitation and requesting that the invitee take action to accept or reject the invitation. The system may also provide an option for the invitee to add the inviter to the contacts database. In either case, after the invitation has been handled, the process 700 ends.

In some embodiments, the system may also use the trust relationship as a means to update contact information for its users. After the system has created a new connection between users according to the method discussed above, the system may automatically exchange contact information between the users. The system may then automatically update the contacts database with the received contact information. In this way, the system uses the existence of the trust relationship to ensure that contact information in the contacts database is up-to-date.

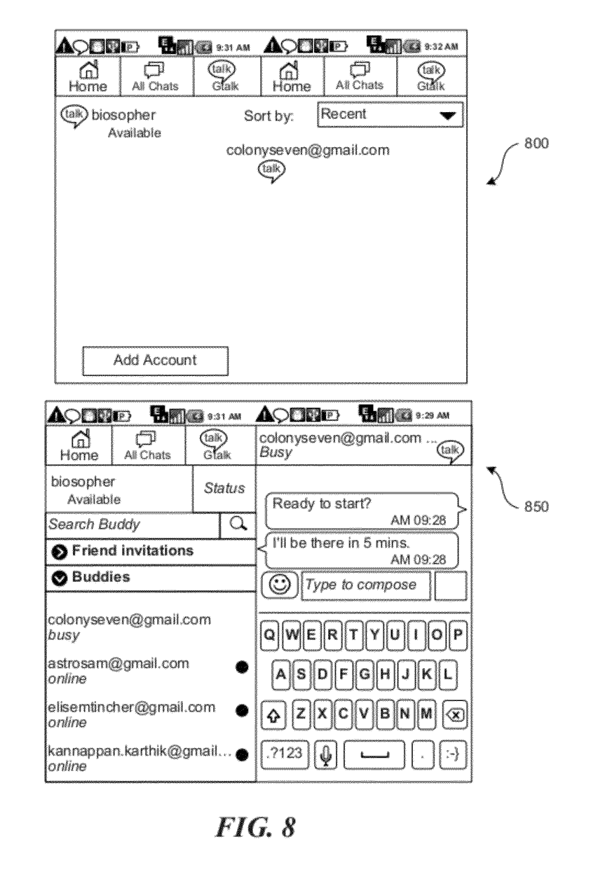

FIG. 8 depicts screenshots 800 and 850 showing a chat application utilizing SMS-based registration.

The chat application can be used with any third party chat applications (e.g., Gtalk, MSN, etc.) including for example XMPP-based messengers. In one embodiment, the ‘join’ button in screenshot 1400 is used to initiate chat provisioning. When the button is selected or clicked, an SMS-based registration process can occur where the client will contact the chat services to create a new account if needed and/or to receive an authentication key. The application may then perform the automatic provisioning processes discussed above.

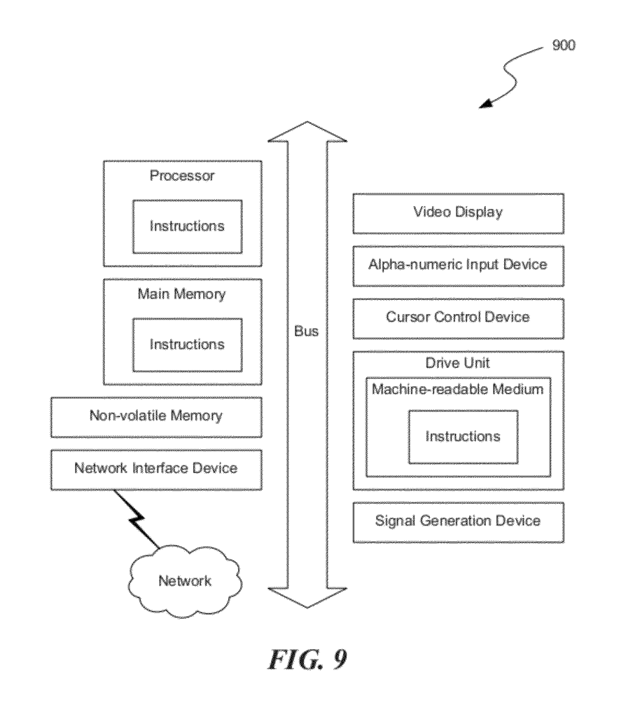

FIG. 9 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples; alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the disclosure.

What is claimed is:

1. A method for automatic provisioning of instant messaging and social networking services, the method comprising:
receiving, at a device associated with a user, a command to join a selected service requiring provisioning of a user account, wherein the selected service is at least one of an instant messaging service or social networking service;
automatically determining an existing user identification associated with the user;
automatically requesting provisioning from the selected service based on the existing user identification; and
automatically sending an invitation to connect through the selected service to an invitee based on contact information accessible by the device and associated with the invitee.

2. The method of claim 1, wherein the existing user identification is a telephone number associated with the device.

3. The method of claim 1, wherein automatically determining the existing user identification comprises querying an application programming interface (API) associated with the device.

4. The method of claim 1, wherein automatically determining the existing user identification comprises sending a request to a proxy server to look up the existing user identification based on an identifier associated with an application on the device.

5. The method of claim 1, wherein automatically determining the existing user identification comprises looking up the existing user identification in a network directory that maps a device-specific identifier to the existing user identification.

6. The method of claim 1, wherein the contact information accessible by the device comprises an address book stored on the device.

7. The method of claim 1, further comprising:
receiving an invitation to connect with an inviter through the selected service; and
automatically accepting the invitation regardless of the identity of the inviter.

8. The method of claim 1, further comprising:
receiving an invitation to connect with an inviter through the selected service;
determining whether information associated with the inviter is stored in a contacts database associated with the device; and
automatically accepting the invitation in response to determining that information associated with the inviter is stored in the contacts database.

9. The method of claim 1, further comprising:
receiving a notification that a connection has been completed with the invitee;
receiving contact information associated with the invitee in response to the connection being completed; and
automatically updating contact information associated with the device based on the received contact information.

10. The method of claim 1, wherein automatically requesting provisioning from the selected service comprises:
determining additional user information based on the existing identification; and
using the additional user information to provision the selected service.

11. A method for automatic provisioning of instant messaging and social networking services, the method comprising:
receiving, at a device associated with an invitee, an invitation to join a selected service from a device associated with an inviter, wherein the invitation is generated based on contact information of the device associated with the inviter and wherein the selected service is an instant messaging service or a social networking service;
determining, at the device associated with the invitee, whether contact information of the device associated with the invitee includes an entry associated with the inviter;
in response to determining that the contact information includes an entry associated with the inviter, automatically accepting the invitation;
obtaining at the device associated with the invitee an existing identification for the invitee; and
using the existing identification for the invitee to provision a user account with the instant messaging or social networking service.

12. The method of claim 11, further comprising:
in response to determining that the contact information does not include an entry associated with the inviter, prompting a user to add the inviter to the contact information.

13. The method of claim 11, wherein the existing user identification is a telephone number associated with the device.

14. The method of claim 11, wherein automatically determining the existing user identification comprises sending a request to a proxy server to look up the existing user identification based on an identifier associated with an application on the device.

15. The method of claim 11, wherein automatically determining the existing user identification comprises looking up the existing user identification in a network directory that maps a device-specific identifier to the existing user identification.

16. The method of claim 11, wherein the contact information comprises an address book stored on the device.

17. The method of claim 11, further comprising:
receiving a notification that a connection has been completed with the inviter;
receiving contact information associated with the inviter in response to the connection being completed; and
automatically updating contact information associated with the device based on the received contact information.

18. A machine-readable storage medium having stored thereon instructions, which when executed, cause a processor to perform a method to automatically provision instant messaging and social networking services, the method, comprising:
receiving, at a device associated with a user, a command to join a selected service requiring provisioning of a user account, wherein the selected service is at least one of an instant messaging service or social networking service;
automatically determining an existing user identification associated with the user;
automatically requesting provisioning from the selected service based on the existing user identification; and
automatically sending an invitation to connect through the selected service to an invitee based on contact information accessible by the device and associated with the invitee.

19. The machine-readable storage medium of claim 18, wherein the existing user identification is a telephone number associated with the device.

20. The machine-readable storage medium of claim 18, wherein automatically determining the existing user identification comprises sending a request to a server to look up the existing user identification based on at least one of an identifier associated with an application on the device or a device-specific identifier.

21. The machine-readable storage medium of claim 18, further comprising:
receiving an invitation to connect with an inviter through the selected service;
determining whether information associated with the inviter is stored in a contacts database associated with the device; and
automatically accepting the invitation in response to determining that information associated with the inviter is stored in the contacts database.

22. The machine-readable storage medium of claim 18, further comprising:
receiving a notification that a connection has been completed with the invitee;
receiving contact information associated with the invitee in response to the connection being completed; and
automatically updating contact information associated with the device based on the received contact information.

23. The machine-readable storage medium of claim 18, wherein automatically requesting provisioning from the selected service comprises:
determining additional user information based on the existing identification; and
using the additional user information to provision the selected service.

24. An apparatus for automatic provision of instant messaging and social networking services, comprising:
means for receiving, at a device associated with a user, a command to join a selected service requiring provisioning of a user account, wherein the selected service is at least one of an instant messaging service or social networking service;
means for automatically determining an existing user identification associated with the user;
means for automatically requesting provisioning from the selected service based on the existing user identification; and
means for automatically sending an invitation to connect through the selected service to an invitee based on contact information accessible by the device and associated with the invitee.

25. A machine-readable storage medium having stored thereon instructions, which when executed, cause a processor to perform a method to automatically provision instant messaging and social networking services, the method, comprising:
receiving, at a device associated with an invitee, an invitation to join a selected service from a device associated with an inviter, wherein the invitation is generated based on contact information of the device associated with the inviter and wherein the selected service is an instant messaging service or a social networking service;
determining, at the device associated with the invitee, whether contact information of the device associated with the invitee includes an entry associated with the inviter;
in response to determining that the contact information includes an entry associated with the inviter, automatically accepting the invitation;
obtaining at the device associated with the invitee an existing identification for the invitee; and
using the existing identification for the invitee to provision a user account with the instant messaging or social networking service.

26. The machine-readable storage medium of claim 25, further comprising:
in response to determining that the contact information does not include an entry associated with the inviter, prompting a user to add the inviter to the contact information.

27. The machine-readable storage medium of claim 25, wherein the existing user identification is a telephone number associated with the device.

28. The machine-readable storage medium of claim 25, wherein automatically determining the existing user identification comprises sending a request to a proxy server to look up the existing user identification based on an identifier associated with an application on the device.

29. The machine-readable storage medium of claim 25, wherein automatically determining the existing user identification comprises looking up the existing user identification in a network directory that maps a device-specific identifier to the existing user identification.

30. The machine-readable storage medium of claim 25, wherein the contact information comprises an address book stored on the device.

31. The machine-readable storage medium of claim 25, further comprising:
receiving a notification that a connection has been completed with the inviter;
receiving contact information associated with the inviter in response to the connection being completed; and
automatically updating contact information associated with the device based on the received contact information.
